(19) United States
(12) Patent Application Publication
(10) Pub. No.: US 2006/0172727 A1
(43) Pub. Date: Aug. 3, 2006

(54) Method of providing one-to-one call during conference call in a mobile terminal

(75) Inventor: Ju-Beam Lee, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/341,820

(22) Filed: Jan. 27, 2006

(30) Foreign Application Priority Data
Jan. 28, 2005 (KR) 2005-8049

(51) Int. Cl. H04M 3/42

(52) U.S. Cl. 455/416

(57) ABSTRACT

A method of providing a conference call function in a mobile terminal. A first mobile terminal requests a one-to-one call to a second mobile terminal by a data burst message during a conference call among a plurality of mobile terminals including the first and second mobile terminals. The second mobile terminal transmits to the first mobile terminal a response indicating whether the one-to-one call request is accepted or rejected by a data burst message. If the second mobile terminal accepts the one-to-one call request, the first mobile terminal transmits a one-to-one call request message to a base station. In response to the one-to-one call request message, the base station connects the first and second mobile terminals in a one-to-one call.

### PRIORITY

This application claims priority under 35 U.S.C. § 119 to an application entitled “Method Of Providing One-To-One Call During Conference Call In A Mobile Terminal” filed in the Korean Intellectual Property Office on Jan. 28, 2005 and assigned Serial No. 2005-8049, the contents of which are incorporated herein by reference.

### BACKGROUND OF THE INVENTION

1. Field of the Invention

The present invention relates generally to a mobile terminal, and in particular, to a method of providing a conference call function.

2. Description of the Related Art

A conference call function in a mobile terminal allows three or more mobile users to communicate with each other on a multi-party call. With the conference call function, the participants each can hear the others' voice and thus a conference can be conducted simply by phone.

Two participants may need to discuss something privately on a one-to-one call during the conference call, so that the other participants do not hear the private conversation.

However, since the mobile terminal does not yet allow them to make a one-to-one call during the conference call, the participants must be disconnected from the conference call and set up a new call between only them. After the one-to-one call, they must again connect to the conference call.

As described above, although the mobile terminal provides the conference call function, it does not enable a one-to-one call during the conference call. Hence, for a one-to-one call during a conference call, participants inconveniently follow the procedure requiring “disconnection from the conference call”, “one-to-one call connection”, “one-to-one call termination”, and “reconnection to the conference call”.

Moreover, the one-to-one call participants cannot reconnect to the conference call until the other participants approve. If they want the private conversation to be unnoticed by the other participants, the one-to-one call is not possible practically.

### SUMMARY OF THE INVENTION

An object of the present invention is to substantially solve at least the above problems and/or disadvantages and to provide at least the advantages described below. Accordingly, an object of the present invention is to provide a one-to-one call during a conference call.

The above object is achieved by providing a method for a conference call function in a mobile terminal. In the method, a first mobile terminal requests a one-to-one call to a second mobile terminal by a data burst Message during a conference call among a plurality of mobile terminals, including the first and second mobile terminals. The second mobile terminal transmits to the first mobile terminal a response indicating whether the one-to-one call request is accepted or rejected by a data burst message. If the second mobile terminal accepts the one-to-one call request, the first mobile terminal transmits a one-to-one call request message to a base station. In response to the one-to-one call request message, the base station connects the first and second mobile terminals in a one-to-one call.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical mobile communication system;

FIG. 2 is a block diagram of a typical mobile terminal;

FIG. 3 is a diagram illustrating a signal flow for a typical conference call; and

FIG. 4 is a diagram illustrating a signal flow for a conference call according to an embodiment of the present invention.

### DETAILED DESCRIPTION OF THE PREFERRED EMBODIMENT

A preferred embodiment of the present invention will now be described with reference to the accompanying drawings. In the following description, well-known functions or constructions are not described in detail since they would obscure the invention in unnecessary detail.

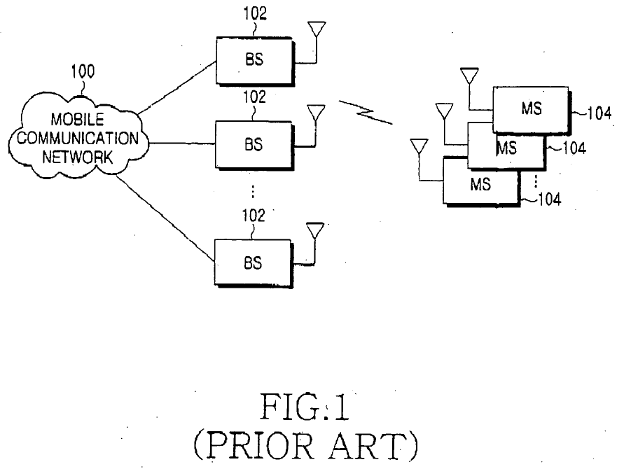

A description will first be made of a typical conference call function with reference to FIGS. 1, 2 and 3, for better understanding of the present invention.

FIG. 1 schematically illustrates the configuration of a mobile communication system in which a plurality of mobile stations (MSs) 104 are wirelessly connected through base stations (BSs) 102 connected to a mobile communication network 100. The MSs 104 wirelessly communicate with the same or different BSs 102 according to their locations.

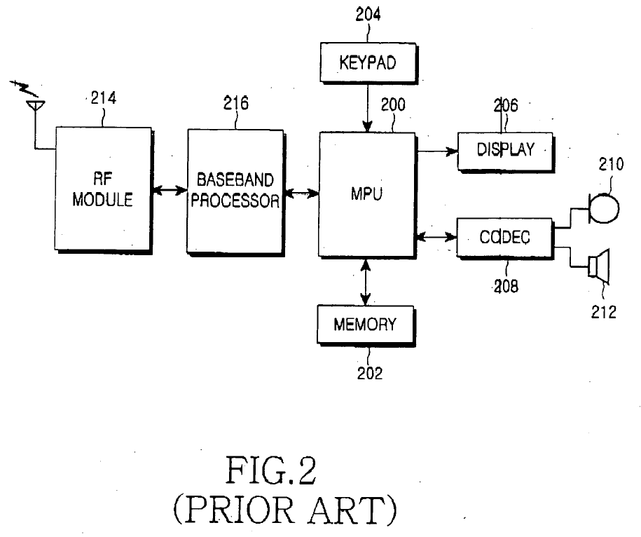

FIG. 2 is a block diagram of a typical MS. Referring to FIG. 2, a micro-processor unit (MPU) 200 takes charge of the functions of the MS including phone call, data communication, wireless Internet connections, etc. A memory 202 stores the micro-codes of programs for processing and control in the MPU 200, and reference data. The memory 202 also provides a working memory for the MPU 200 and an area for storing updatable data to be kept.

A keypad 204 includes keys and provides key input data, corresponding to a key pressed by a user, to the MPU 200. A display 206 displays received or stored images, or images indicating operational information received from the MPU 200 under the control of the MPU 200. A coder-decoder (CODEC) 208 connected to the MPU 200, and a microphone 210 and a speaker 212 connected to the CODEC 208 are used for phone calls and voice recording.

A radio frequency (RF) module 214 transmits/receives radio signals to/from a BS. It modulates a transmission signal received from the MPU 200 through a baseband processor 216 and transmits an RF signal to the BS. It also demodulates a received RF signal received from the BS and provides the demodulated signal to the MPU 200 through the baseband processor 216. The baseband processor 216 processes the baseband signals received from the RF module 214 and the MPU 200.

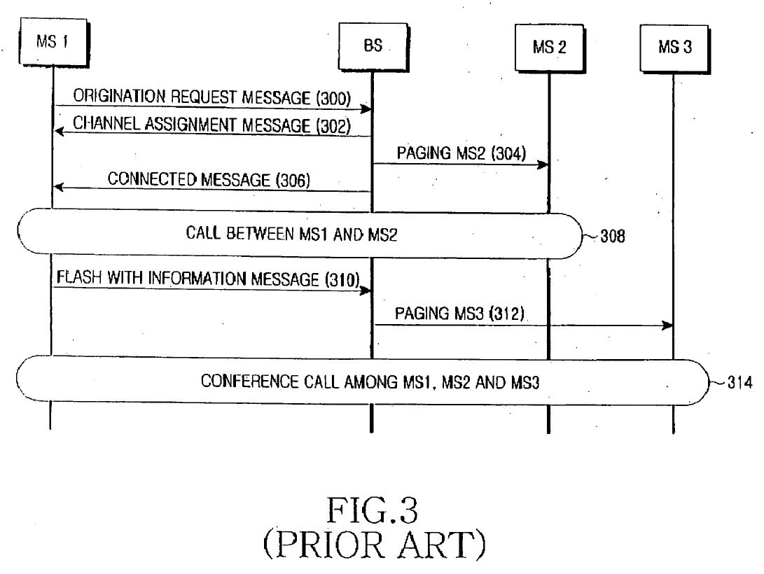

FIG. 3 is a diagram illustrating a signal flow for a typical conference call. Three MSs (MS1, MS2 and MS3) participate in a conference call initiated from MS1 in step 300 through step 314. While only one BS is shown in FIG. 3, one or more BSs may exist depending on the locations of MS1, MS2 and MS3. If the same BS serves MS1, MS2 and MS3, one serving BS exists for them. However, if different BSs serve MS1, MS2 and MS3, as many serving BSs as the number of the MSs are involved in the procedure of FIG. 3. In this case, the BSs are connected to one another over the mobile communication network 100. Also, more MSs may participate in the conference call.

Referring to FIG. 3, MS1 transmits an origination request message to the BS, requesting a call origination to MS2 in step 300. The BS transmits a channel assignment message to MS1 in step 302 and pages MS2 in step 304. When MS2 responds to the incoming call, the BS transmits a connected message to MS1 in step 306 and connects MS1 to MS2 on the call in step 308.

In the connected state, if MS1 and MS2 want to connect MS3 to the call as a conference call, either MS1 or MS2 initiates the conference call. For example, if MS1 attempts to initiate the conference call, MS1 transmits a flash with information message to the BS in step 310. In general, for initiation of the conference call, the user proceeds by pressing a Send key, dialing a phone number, and pressing the Send key. In response to the key inputs, the MPU 200 (illustrated) in FIG. 2 transmits the flash with information message to the BS through the baseband processor 216 and the RF module 214. Here, the phone number of MS3 is dialed. The flash with information message was defined for making a conference call. It contains a message type and a called phone number.

Upon receipt of the flash with the information message from one of MS1 and MS2 during communication, the BS pages MS3 corresponding to the phone number set in the received message, considering that a conference call has been requested in step 312. If MS3 responds to the incoming call, the BS connects MS1, MS2 and MS3 to the conference call in step 314.

If MS1 and MS2 want a one-to-one call during the conference call, the one-to-one call is impossible in the prior art systems without terminating the conference call.

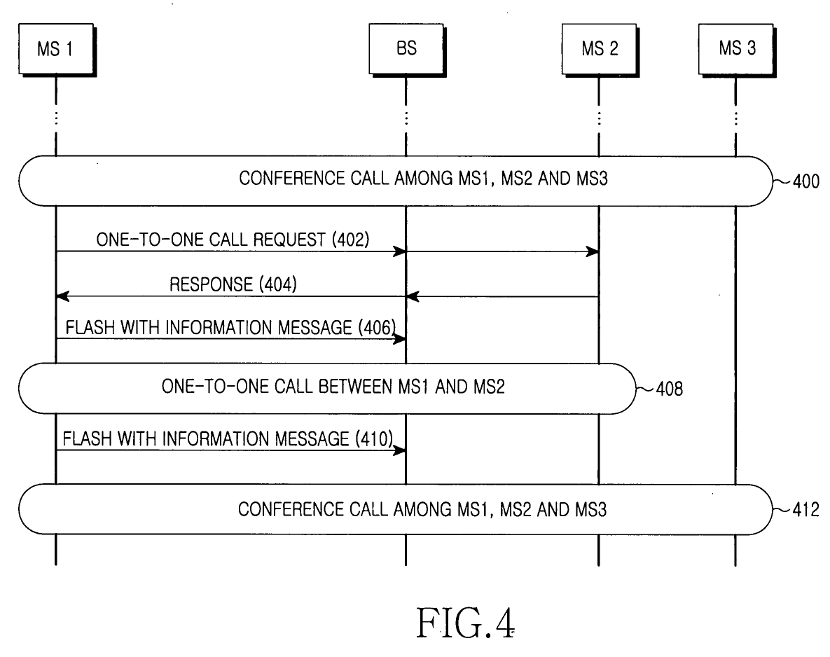

FIG. 4 is a diagram illustrating a signal flow for a conference call according to an embodiment of the present invention. In FIG. 4, MS1 withdraws MS2 from the conference call and makes a one-to-one call with MS2 in steps 400 through step 412. As in FIG. 3, one or more BSs may serve MS1, MS2 and MS3 depending on their locations, however only one BS is shown for convenience. Also, additional MSs can join the conference call.

MS1, MS2 and MS3 have the configuration illustrated in FIG. 2. A “one-to-one call within conference call” menu is added to the existing menu selection to enable a one-to-one call during a conference call according to an embodiment of the present invention. The one-to-one call within conference call menu is used to request a one-to-one call or notify incoming parties of a one-to-one call. With this menu, the other party is notified whether the incoming one-to-one call is accepted and the user is notified whether his one-to-one call request has been accepted. If the one-to-one call is not accepted, the one-to-one call is terminated.

During the conference call among the three MSs in step 400 of the procedure as illustrated in FIG. 3, if MS1 wants to communicate with MS2 on a one-to-one call, MS1 requests a one-to-one call to MS2. To do so, the user of MS1 invokes the one-to-one call within conference call menu by the keypad 204 and inputs a one-to-one call request message during the conference call. MS1 then transmits the one-to-one call request message to MS2 by a data burst message in step 402.

The data burst message is the only message that can carry a user message to another MS in the state where MSs are connected on a call. In the embodiment of the present invention, the data burst message is used to deliver the one-to-one call request message and its response message. The data burst message is transmitted to MS2 through the BS.

Upon receipt of the data burst message requesting a one-to-one call, MS2 displays the one-to-one call request message on the display 206. The user of MS2 then accepts or rejects the one-to-one call request from MS1. MS2 transmits a response indicating acceptance/rejection of the one-to-one call request to MS1 by a data burst message in step 404.

MS1 displays the acceptance/rejection on the display 206. If the one-to-one call request is accepted, the user of MS1 requests the one-to-one call through the keypad 204. In step 406, MS1 then transmits a flash with information message containing the phone number of MS2 to the BS.

Upon receipt of the flash with information message containing the phone number of MS2 from MS1 during the conference call, the BS allocates a new communication channel between MS1 and MS2 and establishes the one-to-one call in step 408. The other MS, MS3 is kept in the conference call state.

To return to the conference call after the one-to-one call, the user of either MS1 or MS2 selects a “one-to-one call end” from the one-to-one call selections within the conference call menu and the corresponding MS transmits a flash with information message to the BS. In FIG. 4, MS1 transmits the flash with information message to the BS in step 410. The BS then terminates the one-to-one call between MS1 and MS2 and returns them to the conference call state in step 412.

In this way, a one-to-one call can be made during a conference call without terminating the conference call by transmitting a one-to-one call request message from a first participant to a second participant, receiving a response message from the second participant by the first participant, and transmitting a flash with information message from the first participant to a BS, requesting the one-to-one call. Therefore, the other participants may continue the conference call irrespective of the private conversation between the two participants.

While the invention has been shown and described with reference to a certain preferred embodiment thereof, it is a mere exemplary application.

While a one-to-one call is made during a conference call among three participants in the embodiment of the present invention, a one-to-one call can be made and released in the same manner during a conference call among a greater number of participants.

In addition, a flash with information message can be replaced with a dedicated message defined between a BS and MSs in order to request one-to-one call initiation and termination. In this case, the dedicated message is configured in the same format as the flash with information message, but with a different message type.

Thus, it will be understood by those skilled in the art that various changes in form and details may be made therein without departing from the spirit and scope of the invention as defined by the appended claims.

What is claimed is:

1. A method of providing a conference call function in a mobile terminal, comprising:
requesting a one-to-one call to a second mobile terminal by a data burst message by a first mobile terminal during a conference call among a plurality of mobile terminals including the first and second mobile terminals;
transmitting a response to the first mobile terminal indicating whether the one-to-one call request is accepted or rejected using a data burst message by the second mobile terminal;
transmitting a one-to-one call request message to a base station by the first mobile terminal, if the second mobile terminal accepts the one-to-one call request; and
connecting the first and second mobile terminals to a one-to-one call by the base station in response to the one-to-one call request message from the first mobile terminal.

2. The method of claim 1, wherein the one-to-one call request message is a flash with information message.

3. The method of claim 1, further comprising:
transmitting to the base station a one-to-one call end request message by one of the first and second mobile terminals, participating in the one-to-one call; and
disconnecting the first and second mobile terminals from the one-to-one call in response to the one-to-one call end request message and returning the first and second mobile terminals to the conference call by the base station.

4. The method of claim 3, wherein the one-to-one call end request message is a flash with information message.

5. A method of providing a conference call function in a mobile terminal, comprising:
requesting a one-to-one call to one other mobile terminal participating in a conference call by a data burst message during the conference call;
transmitting a one-to-one call request message to a base station, if the other mobile terminal accepts the one-to-one call request; and
connecting to the other mobile terminal on a one-to-one call by the base station.

6. The method of claim 5, wherein the one-to-one call request message is a flash with information message.

7. The method of claim 5, further comprising:
transmitting a one-to-one call end request message to the base station; and
returning the mobile terminals participating in the one-to-one call to the conference call, by the base station.

8. The method of claim 7, wherein the one-to-one call end request message is a flash with information message.

9. A method of providing a conference call function in a mobile terminal, comprising the steps of:
receiving a data burst message requesting a one-to-one call from one other mobile terminal participating in a conference call during the conference call;
transmitting to the other mobile terminal a data burst message indicating that the one-to-one call request is accepted; and
connecting to the other mobile terminal on a one-to-one call, by the base station.

10. The method of claim 9, wherein the one-to-one call request message is a flash with information message.

11. The method of claim 9, further comprising:
transmitting a one-to-one call end request message to the base station; and
returning of the mobile terminals participating in the one-to-one call to the conference call by the base station.

12. The method of claim 11, wherein the one-to-one call end request message is a flash with information message.
